(19) United States
(12) Patent Application Publication
(10) Pub. No.: US 2009/0262178 A1
(43) Pub. Date: Oct. 22, 2009

(54) DISC WRITER STORING DATA AND CREATING A VISIBLE IMAGE ON A DISC

(76) Inventors: Lewis S. Ostrover, Los Angeles, CA (US); Christopher J. Cookson, Studio City, CA (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/107,226

(22) Filed: Apr. 22, 2008

(51) Int. Cl. B41J 2/47

(52) U.S. Cl. 347/225

(57) ABSTRACT

A laser disc writer receives a blank disc on which to store data related to content and label information defining a label. Two heads, one disposed on each side of the disc, are used to store data and the label information on the two sides of the disc.

### RELATED APPLICATIONS

The subject matter of this application is related to the application:

“METHOD AND APPARATUS FOR READING OPTICAL DISCS HAVING DIFFERENT CONFIGURATIONS”, application Ser. No. 10/719,308 filed on Nov. 20, 2003 and incorporated herein by reference.

### BACKGROUND OF THE INVENTION

1. Field of the Invention

This invention pertains to a disc writer that stores standard machine-readable data on one or both sides of a double-sided optical disc and creates a visible image on one or both sides thereof.

2. Description of the Prior Art

Typically, recordable or writable DVDs and CDs contain a label on the face of the disc in order to identify the disc and its contents. Traditional labeling technology involves “stick-on” technology, which uses preprinted labels that are attached to the discs with adhesives, or labels can also be printed directly on the disc using appropriate inks. Alternatively, discs are provided with a blank area and a user can write in these areas using a special pen. This later technique is fairly crude and it is believed that it may cause damage to some discs.

Typically, mass-produced optical discs (including DVDS) are formed with successive pits and lands arranged in a spiral to define machine-readable data. In addition, it has been found that the same technique can be used on one side of a disc to generate a visible image as a decoration. The method involves exploiting the optical effect generated by the differences in dimensions between the pits and lands and their respective sizes. These differences are sufficient to form a visible image on the disc, and the resultant images are generally referred to as pit art.

An alternative to these traditional labeling methods was developed by Hewlett-Packard of Palo Alto, Calif., under the name Lightscribe®. The LightScribe® technique involves coating one of the surfaces of a disc with a layer of reactive dye that changes color when it absorbs electromagnetic radiation of a specific wavelength. A disc writer compatible with this technique has a laser head that selectively generates signals in this specific wavelength thereby causing an image to be formed on the dye layer. However, using the LightScribe® technique requires four separate steps: first, a disc with a special coating is provided; second, data is recorded on the other side of the disc; third, the disc is removed and flipped over; and fourth, the image is formed on the specially coated side of the disc. Alternatively, the second and fourth steps are interchanged.

### SUMMARY OF THE INVENTION

The present invention pertains to a device such as a disc writer or recorder used both to store data on a disc and also to create a label or other visible image on the disc. The device can perform both of these operations simultaneously or sequentially and can do so without removing the disc there from.

The device includes a controller and two write heads. In one embodiment, the controller generates a data stream that is sent to a buffer, and then split causing one head to store data on one side and the other head to create a visible image on the other side.

Alternatively, one or both heads are used to store data and create a visible image on either or both sides of the disc.

In one embodiment of the invention, the visible image is created using special dyes coated on the disc, similar to the LightScribe® technique.

At the present it is believed that the pit art technique has been used only on mass produced DVDs to stamp an image on one side while data is stamped on the other side of the disc. In one embodiment of the invention, a similar effect to pit art is achieved in an optical disc writer. Instead of exploiting pit and land dimensions, for this latter case, the disc writer employs the optical difference between written marks and unwritten areas in the disc's internal layer to generate images. This latter technique is referred to herein as the pit art technique for the sake of expediency however it should be understood that physically there are no actual pits or lands created. The pit art technique is used to create images either on one or on both sides of a disc.

Advantageously, discs having several different configuration can be provided using either or both techniques on either side or on both sides thereof.

### BRIEF DESCRIPTION OF THE DRAWINGS

FIG. 1 shows a block diagram of a writer with two laser heads for storing data to a disc and making a label;

FIG. 2 shows a cross section of a disc labeled in accordance with this invention;

FIG. 3. shows a plan view of a first alternate embodiment of the invention with an inner annular label;

FIG. 4 shows a plan view of a second embodiment of the invention with an outer annular label;

FIG. 5 shows a plan view of a third embodiment of the invention with several annular labels;

FIG. 6 shows a plan view a fourth embodiment of the invention with a plurality of inner and/or outer arcuate labels;

FIG. 7 shows a cross-sectional view of a disc with different kinds of labels generated in accordance with this invention;

FIG. 8A shows a partial plan view of the label segments used to render a portion of the label in FIG. 3; and

FIG. 8B shows a partial plan view of an alternate embodiment wherein some of the label segments of FIG. 8A are omitted.

### DETAILED DESCRIPTION OF THE INVENTION

Definitions

The term “disc” or “optical disc” is used to refer to a disc a single sided disc with one or more internal layers for storing data, or a disc with two sides, each side preferably having one or more inner layers made of a material that changes its optical characteristics when exposed to a laser beam. The layer material may be e.g., a dye polymer, a phase change metal alloy, or other materials however in either case, when exposed to a laser, a tiny, microscopic particle of the layer changes its optical characteristics in a manner that mimics or simulates optically the effects of the pits and lands of a mass-produced disc.

As discussed above, the term “pit art technique” is used to refer to a technique of generating an image by applying a laser beam to one of the inner layers of a disc to change visibly the optical characteristics of the layer by simulating the formation of pits and lands.

The term “coated disc” or “dye coated disc” refers to a disc having at least on a portion of one of its surfaces a reactive dye layer.

The term “dye coated technique” is used to refer to a technique of generating an image on one or both sides of a dye-coated disc by applying thereto a laser beam to change the optical characteristics of the dye coated layer in a manner similar to the process in a Lightscribe® device.

The term ‘disc writer’ is used to refer to a device that stores data and generates images either once or many times on either one or both sides of a disc. In most instances the disc writer stores data and creates the image by changing the optical characteristics of the disc particles in spiral pattern extending from the periphery of the disc to a central hub or vice-versa, and in the embodiments described below it is assumed that the disc has this structure as well. However, the particles may be arranged in other geometric configurations as well. For example, the particles may be arranged in concentric circles, or in several separate concentric annular regions with the particles within each region being arranged in a spiral or other configurations. The present invention is applicable to all these configurations as well.

The term “image” or “label” refers to a physical representation on one or both sides of a disc that is visible to the naked eye and may include various logos and other graphical elements, alphanumeric characters, etc. Each image or label is described as being created on a disc using a certain technique. It should be understood that at least in some the embodiments, labels formerly created on a disc can be replaced with new labels using the same techniques that are used to erase data previously stored on a disc and replace it with new data.

Several different embodiments are presented below in which an optical disc is inserted into a disc writer, and data is stored on certain portions of the disc, while an image is formed on other portion(s). The technique for storing data on a disc is well known. Two techniques are presented for creating the images. Each of these may be used for almost any of the different embodiments.

The first technique is the dye coated technique and consists of using a special dye in the predetermined areas of the disc where a label is to be created. Then a laser beam is applied to the respective side or portion of the dye coated disc to create the images. As discussed above, typically the dye is coated on the dye coated disc before the disc is inserted into the writer. The image created by the dye coated technique can be monotonic or can be multicolored.

The second is the pit art technique, in which at least portions of an internal layer are exposed to a laser within the disc writer to generate an image. As discussed above, tiny, microscopic particles of a layer otherwise used for data, are heated by the laser causing the sections to change optical characteristics. These optical characteristics causes an image to be created that is clearly perceptible to the human eye. Importantly, during the pit art technique, the disc is rotated and the head is moved in the same manner as when storing data. These microscopic particles are arranged in a spiral around the center of the disc surface. Of course other geometric arrangements may be used as well. Since the same microscopic particles are now used to create an image, they are also arranged along the same spiral. That is, each image is created from a plurality of arcuate segments, each segment consisting of a plurality of microscopic particles arranged along an arc along the spiral.

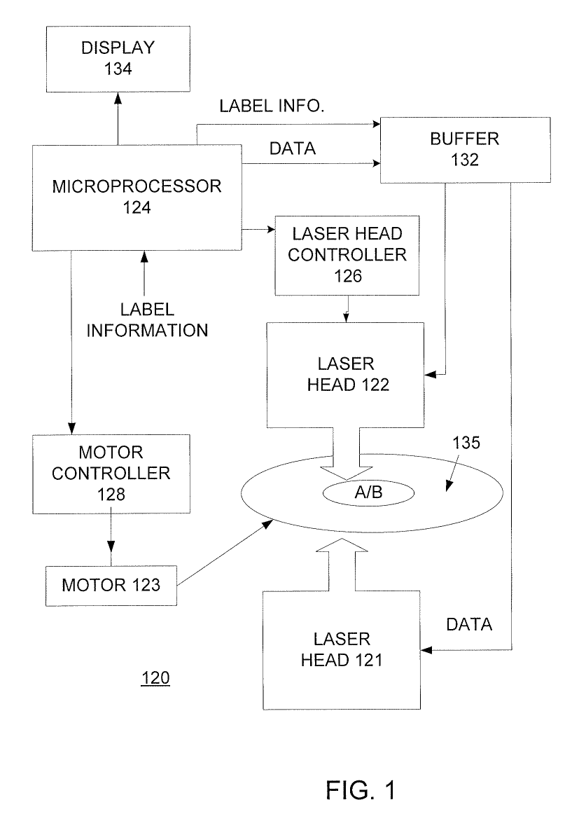

FIG. 1 shows the preferred embodiment of a writer for a disc. Writer 120 has two laser heads 121, 122, a motor 123, a microprocessor 124, a buffer 132, a motor controller 128 and a display 134. The microprocessor generates instructions to the motor controller 128 which in turn rotates disc 135. A laser controller 126 controls the position and operation of laser heads 121, 122.

The display 134 is used to provide a user with instructions for operating the writer 120, including instructions for generating an image, such as a label. The user can then provide label information by a keyboard (not shown), through an external port, such as a USB port (not shown), etc. The label information could include both text and graphics.

The label information and data to be stored on disc 135 is transmitted to the buffer 132. The label information is sent to one laser head 122 while the data is sent to the other laser head 121. The laser head 121 then stores the data using standard protocols while laser head 122 creates an image corresponding to the desired label while the disc 135 is rotated by motor 123. This operation can be performed simultaneously, i.e., data can be recorded on the bottom of disc 135 by laser head 121 as the label is being created on the top of the disc 135. Alternatively, data can be recorded on the disc 135 and the label can be created thereafter, or vice versa. Importantly, the disc 135 in writer 120 is not physically removed from the writer nor is it flipped over during the label creating and data storing process. In an alternate embodiment data and label information are sent to separate buffers before being placed onto the respective sides of the disc.

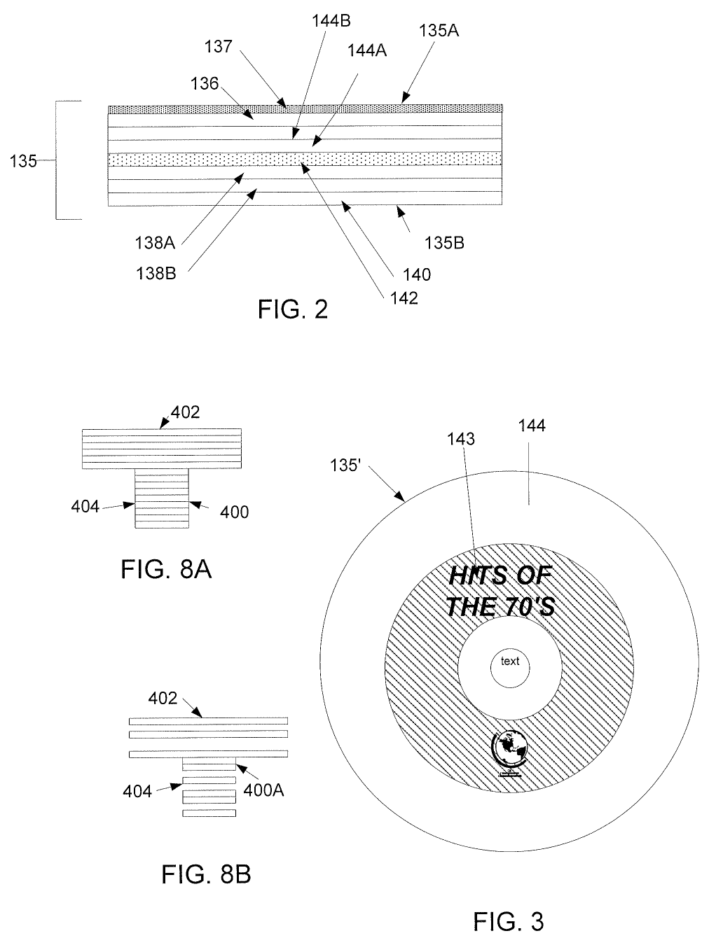

FIG. 2 shows a somewhat diagrammatic cross-section of the disc 135, it being understood that its different dimensions are not shown proportionally. In one embodiment, disc 135 is a dye coated disc so that the top portion 136 is formed with a single layer of a dye 137 disposed. This top portion 136 is selectively exposed to a laser beam from head 122 to generate the image or label. The bottom side 135B is formed with one or two data layers 138A, 138B and is covered by a protective layer 140. The top and bottom sides 135A, 135B are separated by an opaque layer 142. As discussed above, in one embodiment, the laser head 122 creates the label on one side (herein referred to as the top side) 135A of the disc 135 by exposing selective portions of the layer 137 to the laser beam from head 122. Data is stored on one or more layers 138A, 138B on the bottom side. The image can be created on the top side while data is stored on the bottom side. Alternatively, the data storage and image creation steps occur sequentially.

Alternatively, portions of an internal layer on the top side, e.g., portions of layer 144B, are exposed to the laser and a label or image is created using the pit art technique.

In another embodiment, shown in FIG. 3 disc 135′ is formed with an annular label 143 by exposing a portion that covers only an inner section of the disc 135′, thereby leaving annular zone 144 available for data. For example, zone 144 may be formed with two data layers 144A, 144B as shown in FIG. 2. The label can be created first, followed by the storage of data on data layers 144A, 144B, or vice versa. The label 143 can be created using either technique.

In the embodiment of FIG. 3, the disc 135′ includes an annular label 143 surrounded by an annular concentric data area 144. In another embodiment shown in FIG. 4, a disc 150 is shown with a data area 152 disposed in the middle of the disc 150 and an annular label 154. Again, label 154 can be created using either technique.

In another embodiment of the invention, several labels 158, 160 are created, with the annular areas being interlaced between labels 158, 160, e.g., area 162 being used for storing data. This embodiment is shown in FIG. 5. The labels can be created using either the dye coating or the pit art technique.

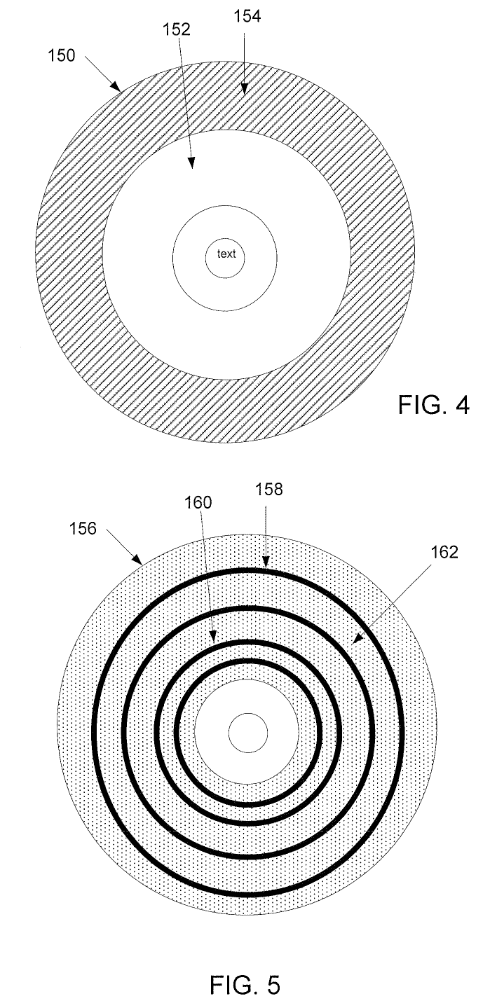

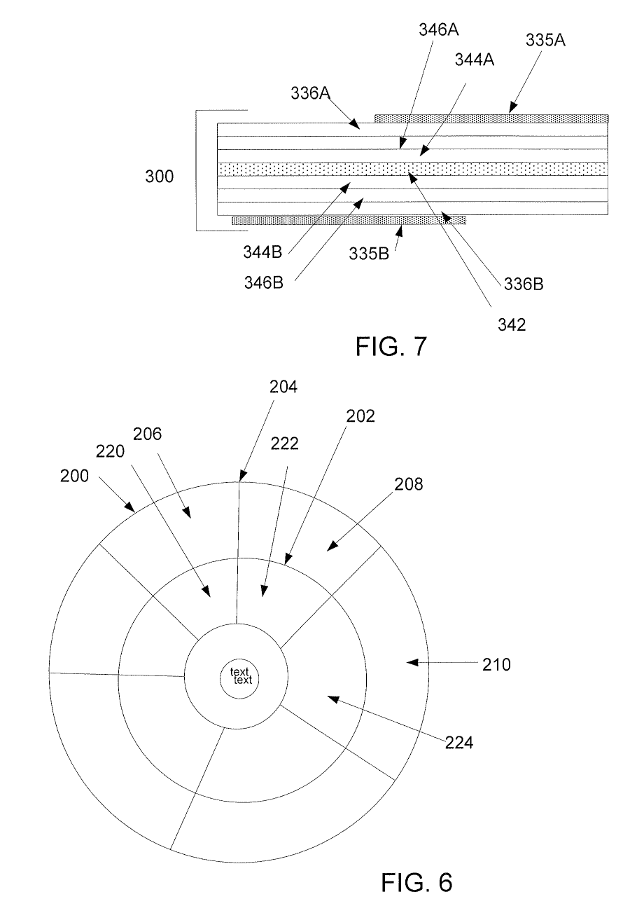

In the embodiments discussed so far, the labels have an annular shape. In other embodiments of the invention, the labels can be arcuate shaped. For example, as shown in FIG. 6. a disc 200 can be partitioned into an inner and an outer annular section by a circular boundary 202, and then each of these annular sections can be further subdivided by radial boundaries such 204. This division results in a plurality of arcuate areas. Some of these areas, including outer areas 206, 210 can be used to create labels, while the areas in between (e.g., 208) can be used to store data. Similarly, inner arcuate areas 220, 224 are used to store data while a label is created in area 222. The labels can be created using either technique.

As discussed above, normally data is stored on a disc layer using pits and lands (or their optical equivalents) disposed around a tightly wound spiral. In the embodiment of the invention shown in FIGS. 4, 5 and 6 one or more layers on each side may be used for both data storage and to create labels or images. Each label consists of several label segments of the spiral, each segment extending in an arc. For the annular labels, the arcs extend around an angle of 360°, with a plurality of label segments being disposed concentrically. For other label segments, the arcs are smaller. However, on any given side or layer of the disc, the spiral that has previously consisted strictly of data, now consists of alternating label and data segments.

In the embodiment described so far, a label area is designated on a disc and then created by rendering an image within the area and leaving the rest of the label area blank or providing in the rest an appropriate background. For example, in the embodiment of FIG. 3, label 143 includes a first element 143A consisting of a plurality of alphanumeric characters, a second area 143B consisting of a graphic design or image and the rest of the label consists of a background 143C. In an alternate embodiment, instead of designating one or more areas, only sufficient segments are created to generate certain alphanumeric characters or graphic images. For example, in FIG. 3, a first set of segments are generated that form the alphanumeric characters 143A, and/;or a second set of segments are created that form the graphic design 143B. In between these segments (e.g., the spaces left between the letters I and T in HITS) are used for data storage and area 143C is omitted.

For example, as shown in FIG. 8A, the top portion 400 of the letter I in FIG. 3 can be rendered from a plurality of adjacent label segments 402 having a first angular arc, and a plurality of adjacent label segments 404 having a smaller arc. (In FIGS. 8A and 8B the label segments 402, 404 are shown as being rectangular, however it should be understood that each of these segments are arcuate. Moreover, for the sake of clarity, only a small number of segments are shown, it being understood that because these segments are very thin, literally hundreds of segments are used to render the labels or images).

In an alternate embodiment shown in FIG. 8B, some of the label segments 402 and 404 are omitted, illustrating that the letter I is still recognizable. The omitted label segments are replaced by corresponding data segments. This structure can be used for any of the labels described herein. Esthetically, the image or label created on the disc is most effective when it is not perceived as being interrupted with two many data segments. From this point of view, the ideal structure is formed by interlacing a large number of data segments with a large number of label segments.

Preferably, especially in the embodiments implemented using the pit art technique, data is stored and the segments generating the respective label are created most efficiently, if the laser head 122 passes over the disc surface 135A in a single pass (at least for a given layer). As the laser head 122 moves across the disc (either radially inwardly or radially outwardly), it stores data in the data portions and generates image elements using respective label segments in the label area, if any. The relative sizes of the label segments and data segments can be defined based on various considerations, including the types of discs being created. For example, one type of DVD disc is logically organized with one set of data portions designated for a first version of a program, and a second set of data portions, interlaced with the first, designated for a second version of a program. For this type of disc, one of the data portions, for example the second set, can be used for the label portion, instead of the second version of a program.

In another embodiment, all the tracks have logical addresses and seamless branching is used to store and read data from the respective data segments. More particularly, a table is generated in which certain physical addresses are used for all the data segments while other physical addresses are used for the label segments. When a data block or sequence of data blocks is read from the disc that spans two data segments, the head reaches the end of the first data segment, skips over the intervening label segment and continues directly to the beginning of the second data segment as defined in the table. Pointers within data blocks rather then a table can also direct the head to skip over label segments in order to read data seamlessly.

In yet another embodiment, it is assumed that a writer reading a particular disc will have a certain minimum buffer size and the largest size of the label portions is then determined from this buffer size. Then as data is read sequentially by the writer from the disc, at the end of a first data segment, the buffer is full so that as the head is passing over the intervening label segment data is read out seamlessly by the writer from the buffer. By the time all the data from the buffer is finished, the head reaches the beginning of the next data segment.

In yet another embodiment, it is assumed that the data from a disc need not be read seamlessly. This is the case where, for example, the data need not be made available immediately, but the user of the client software can wait for it. In this case, as the head reaches the end of one data segment, and starts its pass over the successive label segment, either the reader does not output any data, or it outputs only buffered data and stops the data output when the buffered data runs out. The data output then is restarted when the head starts reading the next data portion.

In the embodiments described above, the bottom side of the disc 135 is dedicated to data while the top side is either dedicated to an image or is used for both an image and data. In another embodiment, a label similar to the ones in FIG. 3, 4 or 5 is created on both sides of a disc. Moreover, either side can be created using either the coated dye or the pit art technique. For example in FIG. 7 a disc 300 is shown having center layer 342, and a top side formed of two inner layers 344A, 346A, a protective layer 336A. All, or a portion of the layer 336A is covered with a dye coating 335A. The bottom side is similar consists of inner layers 344B, 346B and a protective layer 336B. A portion of the layer 336B is at least partially covered by a dye coating 335B.

In accordance with the present invention, either of the dye coatings 335A, 335B or both can be used to create images or labels, using the coated dye technique. Alternatively, or in addition, any of the inner layers can be used to generate labels using the pit art technique. The remaining inner layer is then used for storing data. If the layers 346A, 346B and/or 335A, 335B are used for labels, they must be at least semitransparent to allow data reading and/or storage.

Alternatively, any of the inner layers may be used for label segments radially or tangentially interspaced with data segments to generate labels.

In other words, a label can be created on any of the layers of the disc 300 shown in FIG. 7 using either the dye coating or pit art technique, with data being stored on a separate inner layer. If the label is disposed outwardly of the stored data and overlaps it, it must be made partially transmissive so that the data can be read through the label. Similarly, if data is stored on a disc outwardly of a label, the data must be partially transmissive so that the label can be visible to a person' eye. Alternatively, or in addition, a label can be created and data can be stored on a same layer of the disc, using any of the annular or arcuate configurations shown in the Figures.

Moreover, the images or labels can include various content, including with information, instructions, or ads related or unrelated to the data content. In one advantageous embodiment, a first label is provided on the top side using any of the embodiments discussed above, the label including visual and/or text information related to the content stored on the bottom side. In addition, a second label is provided on the bottom side with visual and text information related to the content stored on the top side. If the disc is rewritable, then the labels can be replaced to match the new content replacing any old content.

Numerous modifications may be made to this invention without departing from its scope as defined in the appended claims.

We claim:

1. An optical disc writer for storing data and creating labels on a blank optical disc comprising:
a controller which sends data and label information for said blank optical disc;
a first laser head receiving said data from said controller and selectively storing said data on one side of said blank disc; and
a second head receiving said label information and creating a corresponding label on the other side of said blank disc, said data being stored and said label being created as the blank disc is rotated.

2. The disc writer of claim 1 wherein said label information and said data are placed on said blank disc simultaneously.

3. The disc writer of claim 1 wherein said label information and said data are placed on said disc sequentially.

4. The disc writer of claim 1 wherein said blank disc is formed with a layer of reactive dye on one side and said label information is formed by said second laser head changing the optical characteristics of said reactive dye.

5. An optical disc writer for providing data and labels on an optical disc having a first and a second side comprising:
a first laser head;
a controller causing data to be stored on one of said first and second side and cooperating with said laser head to modify the optical characteristics of one of said first and second sides to form a label thereon said data being stored and said label being generated without stopping the rotation of the disc therebetween.

6. The optical disc writer of claim 5 wherein said first laser head is disposed along one side of said blank disc and further comprising said second laser head is disposed on the opposite side of said blank disc, each said first and second laser head being adapted to perform one of data storage operation and an image creation on the respective sides.

7. The optical disc writer of claim 6 wherein said data is written on said disc simultaneously with said label.

8. The optical disc writer of claim 6 wherein said data and said label information are recorded sequentially.

9. The optical disc writer of claim 5 wherein said label is generating one of a coated dye technique and a pit art technique.

10. The optical disc writer of claim 6 wherein said label includes at least one of an image and an alphanumeric text.

11. The optical disc writer of claim 5 wherein said label and said data are disposed on said disc in respective label and data segments, said label and data segments being interspaced.

12. The optical disc of claim 5 wherein said label is formed as an annular label.

13. The optical disc of claim 11 wherein said label includes a label portion and wherein said label portion is formed of only adjacent label segments.

14. The optical disc of claim 11 wherein said label includes a label portion and wherein said label portion is formed of label segments interspaced with data segments.

15. The optical disc of claim 5 further comprising a second head wherein both said first laser head and said second laser head receive said data and said label information and store said data and create said label i on the two sides of said blank disc.

16. A method of recording content on a blank disc comprising the steps of:
receiving the blank disc in a writer having a first laser adapted to modify a first side of the disc and a second laser head adapted to modify a second side of the disc;
providing data corresponding to said content to at least one of said laser heads for storing said data on one of said first side and second sides; and
providing label information to at least one of said first and second said laser heads for creating a visible label on one of said sides;
wherein said laser heads store said data and said label on the disc while said disc is rotating.

17. The method of claim 16 wherein said data and said label are placed on said disc simultaneously.

18. The method of claim 16 wherein said data and said label are recorded sequentially.

19. The method of claim 16 wherein a layer of a reactive dye is provided on said second side of said blank disc and said second laser is adapted to change the optical characteristics of said second side to form said visible image.
